(19) United States
(12) Patent Application Publication
(10) Pub. No.: US 2018/0005279 A1
(43) Pub. Date: Jan. 4, 2018

(54) SYSTEM, METHOD, AND RECORDING MEDIUM FOR EMOTIONALLY INTELLIGENT ADVERTISING

(71) Applicant: International Business Machines Corporation, Armonk, NY (US)

(72) Inventors: Roberto Battaglini, Miami, FL (US); Jeremy Ray Fox, Georgetown, TX (US); Leo Kluger, Spring Valley, NY (US); William J. Reilly, Cary, NC (US)

(21) Appl. No.: 15/198,965

(22) Filed: Jun. 30, 2016

(51) Int. Cl. G06Q 30/02

(52) U.S. Cl. CPC G06Q 30/0276; G06Q 30/0275

(57) ABSTRACT

An emotionally intelligent advertising method, system, and non-transitory computer readable medium, include characterizing a first content based on a topic type and an emotional index value, determining if the emotional index value is greater than a threshold emotional index value, and creating a suppression record to suppress a type of advertisement related to the topic type of the first content from being advertised following the first content when the determining determines that the emotional index value is greater than the threshold emotion index value.

### BACKGROUND

The present invention relates generally to an emotionally intelligent advertising method, and more particularly, but not by way of limitation, to a system, method, and recording medium for identifying an emotional index of an advertisement in real-time and making a cognitive decision of the next advertisement to play based on a relation of the emotional index.

Cognitive dissonances can occur between content and advertising or in a sequence of advertising, given any inappropriate sequence of content and advertisement. For example, if a news broadcast is reporting on an earthquake in a region, the advertising during the intermissions, advertisements on a side of the screen such as in a web-page, or the like should not be for a vacation to the same region.

Conventional advertisement control techniques relate to control advertisements based a feature of the user in relation to the content of the advertisement. The conventional techniques consider identifying a type of content and a viewing condition indicating the extent to which the user's attention is focused on the type of content. Based on the viewing condition, the conventional techniques modify the type of content. However, these conventional techniques focus on a condition of the user and fails to address a targeted approach of matching content with advertising based on an emotional index of the content compared to the advertising (e.g., regardless of a user condition).

That is, there is a technical problem in that the conventional techniques do not consider a cognitive way of determining an advertising type based on an emotional index of the content type and the advertising type without the user ever being exposed to the less desirable advertising such that the advertiser's investment is wasted.

### SUMMARY

Thus, the inventors have realized a technical solution to the technical problem to provide significantly more than the conventional technique of advertisement control by identifying an emotional index of content in real time to prevent advertisements with a negative emotional index score above a threshold from being distributed to users following the content to thereby reduce a waste in costs by advertisers and to provide the user with a better viewing experience.

In an exemplary embodiment, the present invention can provide an emotionally intelligent advertising method, the method including characterizing a first content based on a topic type and an emotional index value, determining if the emotional index value is greater than a threshold emotional index value, and creating a suppression record to suppress a type of advertisement related to the topic type of the first content from being advertised following the first content when the determining determines that the emotional index value is greater than the threshold emotion index value.

Further, in another exemplary embodiment, the present invention can provide a non-transitory computer-readable recording medium recording an emotionally intelligent advertising program, the program causing a computer to perform: characterizing a first content based on a topic type and an emotional index value, determining if the emotional index value is greater than a threshold emotional index value, and creating a suppression record to suppress a type of advertisement related to the topic type of the first content from being advertised following the first content when the determining determines that the emotional index value is greater than the threshold emotion index value.

Even further, in another exemplary embodiment, the present invention can provide an emotionally intelligent advertising system, said system including a processor, and a memory, the memory storing instructions to cause the processor to: characterize a first content based on a topic type and an emotional index value, determine if the emotional index value is greater than a threshold emotional index value, and create a suppression record to suppress a type of advertisement related to the topic type of the first content from being advertised following the first content when the determining determines that the emotional index value is greater than the threshold emotion index value.

There has thus been outlined, rather broadly, an embodiment of the invention in order that the detailed description thereof herein may be better understood, and in order that the present contribution to the art may be better appreciated. There are, of course, additional exemplary embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The exemplary aspects of the invention will be better understood from the following detailed description of the exemplary embodiments of the invention with reference to the drawings.

FIG. 1 exemplarily shows a high-level flow chart for an emotionally intelligent advertising method 100.

FIG. 2 depicts a cloud computing node according to an embodiment of the present invention.

FIG. 3 depicts a cloud computing environment according to another embodiment of the present invention.

FIG. 4 depicts abstraction model layers according to an embodiment of the present invention.

### DETAILED DESCRIPTION

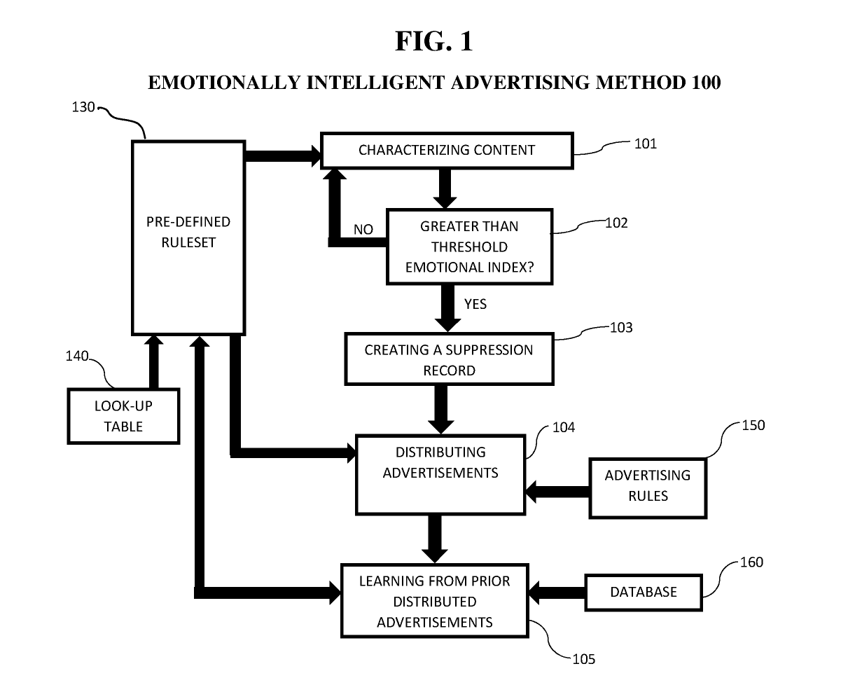

The invention will now be described with reference to FIGS. 1-4, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

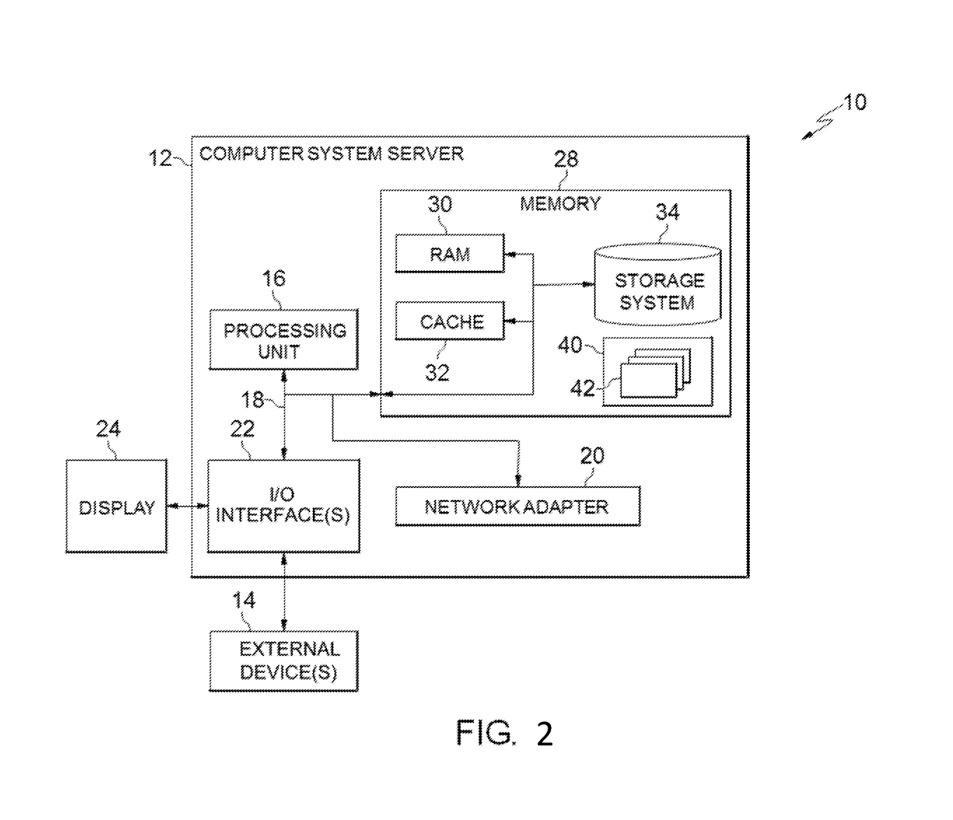

With reference now to FIG. 1, the emotionally intelligent advertising method 100 includes various steps to suppress (or encourage) advertisements based on an emotional index of the content (advertisement) preceding the advertisements. Moreover, the method (system) can benefit from “learning” from past preferences (feedback) of the user. As shown in at least FIG. 2, one or more computers of a computer system 12 can include a memory 28 having instructions stored in a storage system to perform the steps of FIG. 1.

With the use of these various steps and instructions, the emotionally intelligent advertising method 100 may act in a more sophisticated and useful fashion, and in a cognitive manner while giving the impression of mental abilities and processes related to knowledge, attention, memory, judgment and evaluation, reasoning, and advanced computation. That is, a system is said to be “cognitive” if it possesses macro-scale properties—perception, goal-oriented behavior, learning/memory and action—that characterize systems (i.e., humans) that all agree are cognitive.

Cognitive states are defined as functions of measures of a user's total behavior collected over some period of time from at least one personal information collector (e.g., including musculoskeletal gestures, speech gestures, eye movements, internal physiological changes, measured by imaging circuits, microphones, physiological and kinematic sensors in a high dimensional measurement space, etc.) within a lower dimensional feature space. In one exemplary embodiment, certain feature extraction techniques are used for identifying certain cognitive and emotional traits. Specifically, the reduction of a set of behavioral measures over some period of time to a set of feature nodes and vectors, corresponding to the behavioral measures' representations in the lower dimensional feature space, is used to identify the emergence of a certain cognitive state(s) over that period of time. One or more exemplary embodiments use certain feature extraction techniques for identifying certain cognitive states. The relationship of one feature node to other similar nodes through edges in a graph corresponds to the temporal order of transitions from one set of measures and the feature nodes and vectors to another. Some connected subgraphs of the feature nodes are herein also defined as a “cognitive state”. The present application also describes the analysis, categorization, and identification of these cognitive states further feature analysis of subgraphs, including dimensionality reduction of the subgraphs, for example graphical analysis, which extracts topological features and categorizes the resultant subgraph and its associated feature nodes and edges within a subgraph feature space.

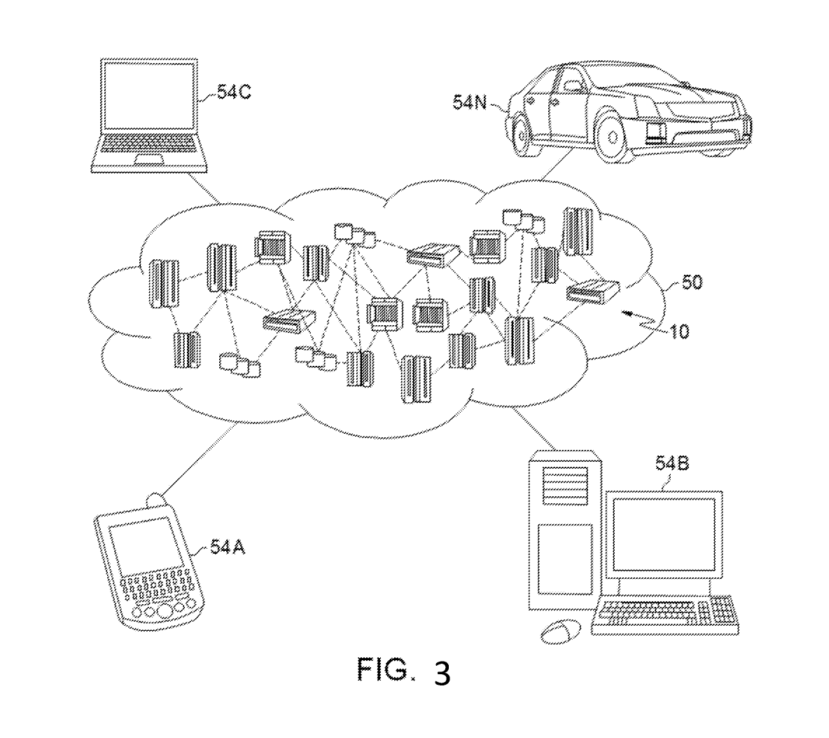

Although as shown in FIGS. 2-4 and as described later, the computer system/server 12 is exemplarily shown in cloud computing node 10 as a general-purpose computing circuit which may execute in a layer the emotionally intelligent advertising system method (FIG. 3), it is noted that the present invention can be implemented outside of the cloud environment.

Step 101 characterizes content being viewed by a user based on a topic type (e.g., type of content) and an emotional index. The content can include, for example, video content such as a news broadcast or entertainment show, an article, an advertisement, etc. Step 101 engages Watson Emotionally Intelligent Advertising (WEIA) or the like, a Software as a Service (SaaS) offering based on cognitive computing technology. Step 101 monitors videos streaming from the Publisher Content Servers, in real time. For example, a user can be watching a news segment as an online video. Step 101 monitors the video feed, using visual and audio recognition techniques to evaluate and categorize the content by a topic type based on a look-up table 140 (e.g., as exemplarily shown in FIG. 3). Once the topic type of the content is identified by Step 102 from the look-up table, Step 101 characterizes the content with an emotional index based on the type of content and a pre-defined ruleset 130 associated with the type of content. That is, the emotional index is based on the pre-defined ruleset 130 (e.g., a translation table, etc.), which assigns emotional intensity scores to different content type scenarios (e.g., a hurricane over the Atlantic Ocean can have a first emotional index that is lower than a second emotional index when the hurricane is over a populated city). That is, the pre-defined ruleset 130 is set such that the characterized topic type can be associated with an emotional index based on a scenario.

The emotional index represents a perceived emotional reaction (e.g., an emotional state, a cognitive state, etc.) by a user while watching the topic type of content. For example, a major disaster or terrorist attack creating a loss of life being reported that day will have a higher emotional index than the major disaster being reported in content ten years after the incident.

For example, the emotional index can be on a scale of 1 to 10 (or the like).

If the emotional index of the content is not greater than a predetermined threshold value in Step 102 (“NO”), Step 101 continuously characterizes the topic type and the emotional index of the topic. The predetermined threshold value can be set as a part of advertising rules 150 of the advertising companies “bidding” for advertisement slots following the current content (e.g., let advertising companies determine their own threshold values for distributing advertisement related to the topic having a certain emotional index). Or, the predetermined threshold can be set as a value based on past user (advertiser) feedback stored in a database 160.

If the emotional index is greater than the threshold value (“YES”) in Step 102, Step 103 creates a suppression record for the topic type. That is, all content characterized with an emotional index of, for example, five or higher would be deemed a “tragic” topic worthy of follow-on content curation. The suppression record includes information of which banner—or the like—advertisements associated with the topic type of the content should not be distributed to the user during the advertisement segments or as pop-up advertisements. For example, if the news segment is characterized by Step 101 as having a topic type of a volcano eruption in Iceland and is characterized with an emotion index greater than the threshold, Step 103 creates a suppression record to suppress advertisements related to the topic type of the content currently being viewed. For example, the suppression record could include information to suppress travel advertisements to Iceland whereas conventional advertisement customizing techniques identify the topic type of Iceland and recommend advertisements including Iceland.

In other words, Step 103 creates a suppression record to suppress advertisements following the content when a topic type of the advertisement is associated with the topic type of the content and the emotional index of the content is greater than the threshold value.

It is noted that Step 103 creates the suppression record comprising a negative suppression record including information on which topic types of advertisements to avoid distributing and a positive suggestion record including information of a topic type for positively-associative advertising content countering the negative topic type. The positive suggestion record is the counterpart to the negative suppression record in that the positive suggestion record includes information on topic types that would best match the emotional index of the content. For example, an advertisement for the Red Cross or charitable donations can be encouraged based on the characterized topic type (e.g., a disaster, world tragedy, etc.). That is, an advertisement for charitable donations for victims of the volcano eruption will be received better by the users right after watching a news segment on the volcano eruption and the positive suggestion record suggests this distribution.

Further, the advertisements include pre-defined data indicating which type of suppression record suppress the advertisements as part of the advertising rules 150.

The suppression record or suggestion record is shared (configured) with the advertising rules 150 (e.g., the Publisher Advertisement Server and the Data Management Platforms that are elements in the display advertising process). Also, the user information is included in the advertising rules 150 as authorized by a user.

Step 104 distributes the advertisements according to a bidding process using the suppression record (suggestion record) as an additional input to the advertising rules 150 to manage the bidding to distribute the advertisements. That is, demand side platforms (e.g., advertisers having customized advertising rules 150) receive the suppression record (suggestion record) and apply their own interpretation and rules to the data including the suppression record. In this way, individual advertisers can set up their own threshold value for the emotional index or preferences on when to distribute advertisements according to the suppression record. That is, the advertising rules 150 can include no change to a standard bid process, avoid or low-weight various categories of undesirable advertisement types (e.g., based on the suppression record), prioritize certain categories of desirable advertisement types (e.g., based on the suggestion record), etc.

In other words, Step 104 distributes the advertisement(s) to the user based on advertising rules associated with the suppression record of an advertiser.

Also, conventional user customized advertisements can be better customized to the user using the user data and the additional input of the suggestion record. That is, the suggestion record can better customize advertisements to the user based on the user information and a predicted emotional state of the user after or while watching the previous content.

Step 105 updated the pre-defined ruleset 130 based on prior distributed advertisements. That is, Step 105 can data-mine social media, a blog, feedback from users, advertiser feedback, etc. to intelligently learn emotional index rules for more accurately characterizing the emotional index for a topic type. For example, if social media includes posts that an advertisement distributed after a topic type was “insensitive”, “inconsideration”, had a negative connotation, etc., Step 105 updates the pre-defined ruleset to increase an emotional index value of the content or to associate different advertisement topics to be related to the topic type. In the volcano eruption example for Iceland, the advertisements for travel to Iceland were suppressed. However, if advertisements related to an Iceland national team losing a competition were not suppressed and there is negative connotation with this advertisement on social media following a news broadcast for the volcano eruption, Step 105 updates the suppression record to suppress advertisements related to Iceland national teams.

Similarly, if the pre-defined ruleset included a low emotional index for a topic and did not create a suppression record because the emotional index did not exceed the threshold, and there is a subsequent social media uproar over advertisements being distributed related to the topic type of the content that should have been suppressed, Step 105 can learn from this activity and update the pre-defined ruleset to have a higher emotion index for the topic type of content.

It is noted that the invention is not intended to be limited to content followed by an advertisement but can include an advertisement being characterized and the following advertisement (or content) being suppressed based on the emotional index of the advertisement.

Further, the method 100 can be applied to, for example, digital content that appears not only in a classic browser, but also across video players, connected televisions, mobile devices, any analogous digital content systems providing streaming media, etc.

Thus, by creating the suppression record (suggestion record) based on a perceived emotional state of the user from a pre-defined ruleset entirely based on a topic type of the content, advertisements related to the topic type can be suppressed by only characterizing the topic type and emotional index of the content and the topic type of the advertisements (e.g., user data does not need to be collected). Also, because the pre-defined ruleset is based on a look-up table, the look-up table and ruleset can be improved based on machine learning. Even further, the distributing of the advertisements can be performed according to advertising rules of advertising companies such that the bidding process (or the like) can include another input of the suppression record (suggestion record).

In one embodiment, an online advertising publisher can apply Watson-like cognitive computing to news or other video-oriented websites or digital domains. In real-time, or near-real time the cognitive system would evaluate online video or other content by its topic matter and emotional index, and characterize the content by disaster topic and emotional intensity, according to pre-defined rules (e.g., Step 101). If the video content covered a tragic disaster that passes an emotional index threshold (e.g., Step 102), a suppression record can be created (injected) into the online display advertising process, specifying that banner ads associated with the disaster topics should not be selected or auctioned during online bidding and ad selection (e.g., Step 103 and Step 104). The suppression record can also have a positive counterpart (e.g., the suggestion record). Disaster-content presents an opportunity to identify and supply provide positively-associative advertising content, such as Red Cross charitable fund-raising programs.

That is, the method 100 can utilize cognitive computing to analyze and characterize unstructured content, as part of a method to identify and subsequently suppress what is sometimes inadvisable content.

In one working embodiment and only for exemplary purposes, it is noted that the look-up table 140 can comprise various public domain categorizations of disasters as one type of look-up table 140. Table 140 would preferably reference an up-to-date, real time database containing disaster information. For example, one look-up table 140 is maintained by Catholic University of Louvain Centre for Research on the Epidemiology of Disasters. Other such classification systems could also be used as the look-up table 140 with appropriate adjustments to the scaling, ranking and thresholds (e.g., rules) set in the pre-defined ruleset 130. For example, the Centre for Research on the Epidemiology of Disasters (CRED) maintains an Emergency Events Database, or EM-DAT, which contains essential core data on the occurrence and effects of over 18,000 mass disasters in the world from 1900 to present. The database is compiled from various sources, including United Nation agencies, non-governmental organizations, insurance companies, research institutes and press agencies.

For a disaster event to be recorded into the EM-DAT database, at least one of the following criteria must be fulfilled: Deaths: 10 or more people deaths; Affected: 100 or more people affected/injured/homeless; Declaration/international appeal: Declaration by the country of a state of emergency and/or an appeal for international assistance; Event name: Any specification related to the disaster which allow its identification (i.e. “Mitch” for the name of storm, “Airplane 1” for the type of plane in an air crash, name of the diseases such as “Cholera” for an epidemic, “Etna” for the name of the volcano, etc.); Glide Number: The Global Identifier number (GLIDE; further information available on www.glidenumber.net) is a globally common Unique ID code for disasters intended to facilitate linkages between records in diverse disaster databases and disaster exchange information websites such as “ReliefWeb”.

It is further noted that “disasters” can include natural, technological and “complex” disasters, as outlined by CRED. Disasters can also include man-made attacks, such as terrorism.

The look-up table 140 would preferably reference an up-to-date, real time database containing disaster information. Candidate data sources could also include the Complex Emergency Database (CE-DAT), which is maintained by the Centre for Research on the Epidemiology of Disasters (CRED). CE-DAT is a database of mortality and malnutrition rates—the most commonly used public health indicators of the severity of a humanitarian crisis. CE-DAT monitors and evaluates the health status of populations affected by complex emergencies.

Another example for the look-up table 140 could be the Emergency Response Safety and Health Database (ERSH-DB), a rapidly accessible occupational safety and health database developed by the National Institute for Occupational Safety and Health (NIOSH). The ERSH-DB contains accurate and concise information on high-priority chemical, biological and radiological agents that could stem from a terrorist event.

A further example for the look-up table 140 could be the disaster databases and other information sources provided by or referenced by www.data.gov. One such referenced data service is GeoQ, which crowdsources geo-tagged photos of disaster-affected areas.

Thus, if a news article (e.g., a first content) covers or mentions or references one or more “Complex Emergency” as defined by CE-DAT (e.g., the look-up table), then advertisements promoting related (but cognitively dissonant) goods or services should also be suppressed immediately following the news broadcast/sharing/transmitting.

In another embodiment, a web browser based cookie associated with each user includes timestamp data elements that record when the user was “exposed” to (viewed) the disaster news article (e.g., first content). These records are maintained as elements in the user's cookie indefinitely. Another embodiment can “reset the timestamp clock” based on repeated viewings of information related to a given disaster, again, as recorded in the cookie.

In another embodiment, advertising placement decision makers will have an option to choose how long they want their advertising tactics to take a suppression (suggestion) record (e.g., a disaster record) into consideration when placing advertisements. For example, one day or up to a week after viewing web content or a clip about a “major” disaster (as calculated based on the timestamp in the cookie) the suppression record would be used to support dynamic decisions regarding where and when and how to place a particular advertisement. But, eight or more days after the event, that suppression record will be ignored, unless the viewer again views a related video.

In another alternative embodiment, the suppression record can suppress advertisements based on disasters that occur, while also taking geographic rationality into account. For example, if a natural or technological disaster occurs in the US, then that disaster will be categorized by CRED with an appropriate Country Code or ISO code.

That is, for a given disaster, geographic data is extracted from CRED records (e.g., the look-up table 140), along with other details about the disaster. This processing takes place either through a centralized server or through algorithms operating on any of the servers that support advertisement placement processes.

The regionalization can occur at any of the following levels, amongst others. Advertising professionals can specify (e.g., create a rule in the pre-defined ruleset 130) at any level of rationality they want to take a given suppression (disaster) record into consideration when making tactical advertisement placement decisions. For example, the geographical information of the look-up table 140 can be sourced from EM-DAT guidelines using a “Country” in which the disaster has occurred or had an impact; with the name and spelling being taken from standard list of country names published by the International Standards Organization (ISO). If a disaster has affected more than one country, there will be one entry for each country. Also using an “ISO Code” for Standardization attributes a 3-letter code to each country and the field is automatically linked to the country. Further, “Region” can be used as the region to which the country belongs and is automatically linked to the country. Further, “Continent” can be used and is automatically linked to the country. In addition, the geographical information of the look-up table 140 for the EM-DAT guidelines can include “River basin” (e.g., name of the river basins of the affected area (used usually for flood event)), “Latitude” (e.g., North-South coordinates; when available (used for earthquakes, volcanoes and floods)), “Longitude” (e.g., East-West coordinates; when available (used for earthquakes, volcanoes and floods)), and “Location” (e.g., a geographical specification (e.g. name of a city, village, department, province, state, or district)). Also, coordinate in a “Global Positioning System” (GPS) can be used to link nearby locations. Using a location can allow for the subsequent analysis of disaster occurrence and impact by region, district or any other sub-national administrative boundary.

In one embodiment, a suppression record can be created if the magnitude of the disaster falls above a predetermined threshold (e.g., a rule of the pre-defined ruleset 140) as a first scenario. Alternatively, if a disaster's magnitude is above a pre-specified but variable threshold, as decided by an advertising placement professional or equivalent, then an ad would not be placed, would not run, due to the presence of a suppression record as a second scenario.

For either of the first scenario of the second scenario, thresholds can be based on commonly-accepted disaster magnitude scale and value factors, which would in turn drive assignments of an emotional index associated with the disaster as part of a ruleset of the pre-defined ruleset 130 (e.g., an earthquake measured by Richter Scale, a flood measured by square kilometers (area covered), extreme Temperature measures in degrees of Celsius, an epidemic measured in a number of vaccinated, etc.).

Other factors (e.g., rules of the pre-defined ruleset 130) that can determine when a critical threshold has been passed could include, for example, a number of deaths associated with the disaster. For example, if the number of deaths were between 10 and 15, then the emotional index would receive a low value such as 1. Consequently, no suppression record would be created. But, if the number of deaths associated with the disaster were 16 to 24, then the emotional index would be given a score of 3. Consequently, a suppression record might be created. Or, if the number of deaths associated with the disaster were 25 or higher, then the emotional index would be given a score of 5. Consequently, a suppression record would likely be created. A more granular scale might be more appropriate and could be useful (e.g., the scale is not limited to this embodiment). Different scales might be used for different domains.

The rules of the pre-defined ruleset 130 can also be based on one of or a combination of, for example, a number of people confirmed dead and number missing and presumed dead (e.g. “killed”), a number of people suffering from physical injuries, trauma or an illness requiring immediate medical treatment as a direct result of a disaster (e.g., “injured”), a number of people needing immediate assistance for shelter (e.g., displaced people), a number of people requiring immediate assistance during a period of emergency; this may include displaced or evacuated people (e.g., “affected”), a sum of killed and total affected (e.g., “victims”), a global figure of the economic impact of a disaster (e.g., “estimated damage”), etc.

For example, a threshold rule of the pre-defined ruleset 130 could be established such that if the number of total victims are 20 or higher, then the emotional index could be assigned a relatively high number by Step 101 and subsequently a suppression record would be turned on added by Step 103. Or, if the number of total displaced was 50 or above, then the emotional index could be assigned a relatively high number by Step 101, and a suppression record would be turned on or added by Step 103. Or, if the radiation level were of the scale of the 1986 Chernobyl explosion, which released about 100 million curies (or a meaningful fraction thereof), then the emotional index could be assigned a relatively high number by Step 101 and a suppression record element would be turned on or added by Step 103.

In one embodiment, the look-up table 140 can be based on a database of the National Animal Care & Control Association Disaster Database. Similar databases can be appropriate to review as part of the overall process, as people are understandably affected by the death or injury to animals. In the embodiment, certain predetermined yet variable thresholds can be established to determine whether or not a given disaster or event affected a “critical” number of animals, at a level sufficient enough to inject a suppression record.

It is noted that although the embodiments describe a “disaster” as the content, the invention is not limited to disaster characterizations. That is, the content can include any event in which a look-up table 140 is created and a pre-defined ruleset 140 for characterizing the content. For example, the content can include a winner of an election in which the suppression record would indicate to suppress all advertisements for the losing candidate.

Exemplary Hardware Aspects, Using a Cloud Computing Environment

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 2, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

As shown in FIG. 2, computer system/server 12 in cloud computing node 10 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 3, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 3 are intended to be illustrative only and that computing nodes 10 and cloud computing environment 50 can communicate with any type of computerized circuit over any type of network and/or network addressable connection (e.g., using a web browser).

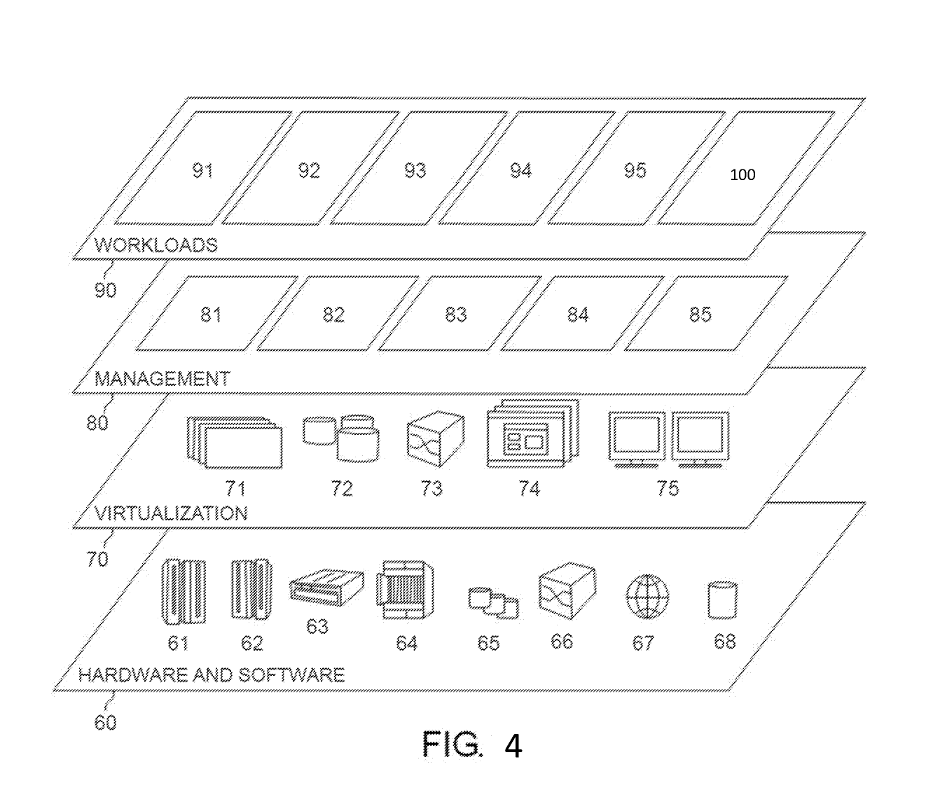

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the anti-counterfeiting system 100 and the anti-counterfeiting system 600 described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. An emotionally intelligent advertising method, the method comprising:
characterizing a first content based on a topic type and an emotional index value;
determining if the emotional index value is greater than a threshold emotional index value; and
creating a suppression record to suppress a type of advertisement related to the topic type of the first content from being advertised following the first content when the determining determines that the emotional index value is greater than the threshold emotion index value.

2. The method of claim 1, wherein the creating further creates a suggestion record to suggest a positively-associative type of advertisement that counters the topic type of the first content to be advertised following the first content.

3. The method of claim 2, wherein the suggestion record indicates a positive perceived emotional reaction by a user when viewing the type of advertisement following the first content, and
wherein the suppression record indicates a negative perceived emotional reaction by the user when viewing the type of advertisement following the first content.

4. The method of claim 1, wherein the characterizing characterizes the topic type according to a look-up table including a plurality of events, and
wherein the characterizing sets the emotional index value of the first content based on a pre-defined ruleset associated with the topic type.

5. The method of claim 2, wherein the look-up table comprises a plurality of events associated with the topic type to match to the first content, and
wherein the pre-defined ruleset for characterizing the emotional index value is based on the plurality of events.

6. The method of claim 2, wherein the pre-defined ruleset is set such that the topic type is associated with the emotional index value based on a scenario of the first content in the look-up table being detected.

7. The method of claim 1, wherein the emotional index value is characterized according to a perceived emotional reaction of a viewer of the advertisement when the advertisement is advertised following the first content.

8. The method of claim 1, wherein the threshold emotional index value is set based on an advertising rule of an advertiser.

9. The method of claim 1, further comprising distributing the type of advertisement of the suppression record when the emotional index value is greater than the threshold emotional index value based on an advertising rule of an advertiser setting a different threshold emotional index value.

10. The method of claim 1, further comprising distributing an advertisement based on an advertising rule of an advertiser.

11. The method of claim 1, further comprising distributing an advertisement based on an advertising rule utilized during a bidding process,
wherein the advertising rule comprises a first rule to avoid the type of advertisement associated with the suppression record.

12. The method of claim 1, further comprising distributing an advertisement based on an advertising rule utilized during a bidding process,
wherein the advertising rule comprises:
a first rule to avoid the type of advertisement associated with the suppression record; and
a second rule to prioritize the type of advertisement associated with the suggestion record.

13. The method of claim 1, wherein the characterizing sets the emotional index value of the first content based on a pre-defined ruleset associated with the topic type, and
the method further comprising learning a new pre-defined ruleset based on data related to an emotional perception of a user for an advertisement advertised following the first content.

14. The method of claim 13, wherein the data related to the emotion perception of the user is collected from at least one of:
social media;
a feedback of the user; and
a feedback of an advertiser.

15. The method of claim 1, further comprising learning a pre-defined ruleset for characterizing the emotional index value based on data related to an emotional perception of a user for an advertisement advertised following the first content.

16. A non-transitory computer-readable recording medium recording an emotionally intelligent advertising program, the program causing a computer to perform:
characterizing a first content based on a topic type and an emotional index value;
determining if the emotional index value is greater than a threshold emotional index value; and
creating a suppression record to suppress a type of advertisement related to the topic type of the first content from being advertised following the first content when the determining determines that the emotional index value is greater than the threshold emotion index value.

17. The non-transitory computer-readable recording medium of claim 16, wherein the creating farther creates a suggestion record to suggest a positively-associative type of advertisement that counters the topic type of the first content to be advertised following the first content.

18. The non-transitory computer-readable recording medium of claim 17, wherein the suggestion record indicates a positive perceived emotional reaction by a user when viewing the type of advertisement following the first content, and
wherein the suppression record indicates a negative perceived emotional reaction by the user when viewing the type of advertisement following the first content.

19. The non-transitory computer-readable recording medium of claim 16, wherein the emotional index value is characterized according to a perceived emotional reaction of a viewer of the advertisement when the advertisement is advertised following the first content.

20. An emotionally intelligent advertising system, said system comprising:
a processor; and
a memory, the memory storing instructions to cause the processor to:
characterize a first content based on a topic type and an emotional index value;
determine if the emotional index value is greater than a threshold emotional index value; and
create a suppression record to suppress a type of advertisement related to the topic type of the first content from being advertised following the first content when the determining determines that the emotional index value is greater than the threshold emotion index value.
